(19) United States
(12) Patent Application Publication
(10) Pub. No.: US 2016/0173441 A1
(43) Pub. Date: Jun. 16, 2016

(54) METHOD AND APPARATUS FOR ALLOCATING IP ADDRESS BY DIRECT COMMUNICATION TERMINAL

(71) Applicant: Electronics and Telecommunications Research Institute, Daejeon (KR)

(72) Inventors: Hyun LEE, Daejeon (KR); Ho Young SONG, Daejeon (KR)

(21) Appl. No.: 14/886,268

(22) Filed: Oct. 19, 2015

(30) Foreign Application Priority Data
Dec. 10, 2014 (KR) 10-2014-0177466

(51) Int. Cl. H04L 29/12; H04L 5/00

(52) U.S. Cl. CPC H04L 61/2007; H04L 5/0055; H04L 61/6022

(57) ABSTRACT

The present invention relates to a method and an apparatus for allocating an Internet Protocol (IP) address by a direct communication terminal which selects a first local IP address that is a local IP address of a first terminal, transmits an IP address verification request message including the first local IP address to a second terminal, receives an IP address verification response message including information on duplication of the first local IP address, and determines whether to use the first local IP address based on the IP address verification response message.

### CROSS-REFERENCE TO RELATED APPLICATION

This application claims the priority benefit of Korean Patent Application No. 10-2014-0177466, filed on Dec. 10, 2014, in the Korean Intellectual Property Office, the disclosure of which is incorporated herein by reference.

### BACKGROUND

1. Field of the Invention

Embodiments of the present invention relate to a method and a terminal for dynamically allocating an Internet Protocol (IP) address between direct communication terminals.

2. Description of the Related Art

A conventional Internet Protocol (IP) allocation technique needs a Dynamic Host Configuration Protocol (DHCP) server to dynamically allocate an IP address. In a wireless network in infrastructure mode, an access point is connected to a wire-based DHCP server to perform an IP address allocation service.

Thus, in direct communications between terminals, a particular terminal is required to serve as a DHCP server to allocate an IP address.

When a particular terminal serving as a DHCP server moves, it may become difficult to manage an IP address.

Therefore, a technique for allocating an IP address is needed even when a predetermined terminal doesn't serve as a DHCP server.

### SUMMARY

An aspect of the present invention provides a method and an apparatus for allocating an IP by a direct communication terminal.

In detail, each terminal autonomously selects an IP address, and verifies and adjusts availability of the IP address in coordination with another terminal linked via direct communications, thereby allocating an IP address.

According to an aspect of the present invention, there is provided a method of allocating an IP address by a first terminal, the method including: selecting a first local IP address that is a local IP address of the first terminal; transmitting an IP address verification request message including the first local IP address to a second terminal; receiving an IP address verification response message indicating whether the first local IP address is included in a local IP address of the second terminal or an IP address list of the terminals linked to the second terminal; and determining whether to use the first local IP address based on the IP address verification response message.

The selecting of the first local IP address may select the first local IP address by using a clock counter value and a hardware identifier value of the first terminal.

The selecting of the first local IP address may store a local IP address used when power of the first terminal is turned off, and select the stored local IP address as the first local IP address when power of the first terminal is turned on.

The transmitting of the IP address verification request message to the second terminal may transmit the IP address verification request message to the second terminal after a delay of a predetermined time since a link to the second terminal is established.

The transmitting of the IP address verification request message to the second terminal may transmit the IP address verification request message to the second terminal by further including hardware identifier information on the first terminal in the IP address verification request message.

The receiving of the IP address verification response message may determine that an IP address verification response message corresponding to a negative verification response (Nack) is received when the IP address verification response message is not received for a preset period of time.

The determining of whether to use the first local IP address may determine that the first local IP address is included in the IP address of the second terminal or the IP address list of the terminals linked to the second terminal when the IP address verification response message corresponding to a positive verification response (Ack) is received a second preset number of times for a second preset period of time, and determine that the first local IP address is not included in the IP address of the second terminal or the IP address list of the terminals linked to the second terminal when the IP address verification response message corresponding to a negative verification response (Nack) is received a third preset number of times for a third preset period of time, the first preset period of time, the second preset period of time, and the third preset period of time may be partly the same, all the same, or all different, and the first preset number of times, the second preset number of times, and the third preset number of times may be partly the same, all the same, or all different.

The first preset period of time and the first preset number of times may be set in view of at least one of number of terminals linked to the first terminal and number of terminals with which the first terminal is establishing a link.

The method of allocating an IP address by a first terminal may further include performing communication with the second terminal using the first local IP address when the first local IP address is available as a result of the determining of whether to use the first local IP.

The method of allocating an IP address by a first terminal may further include, when the first local IP address is unavailable as a result of the determining of whether to use the first local IP address, transmitting an IP address verification request message including a new local IP address to the second terminal and receiving an IP address verification response message with respect to the new local IP address to determine whether to use the new local IP address.

The method of allocating an IP address by a first terminal may further include, when it is determined that the new local IP address is used for the first terminal, transmitting, by the first terminal, the new local IP address to all terminals linked to the first terminal to update the IP address of the first terminal.

The method of allocating an IP address by a first terminal may further include, when the received IP address verification response message is a negative verification response (Nack) and includes a second local IP address that is the local IP address of the second terminal, determining whether the second local IP address is included in an IP address list of the terminals linked to the first terminal; and responding to the second terminal depending on a determination result, and the responding to the second terminal may transmit an IP address verification response message corresponding to a positive verification response (Ack) to the second terminal when the second local IP address is included in the IP address list of the terminals linked to the first terminal, and transmit an IP address verification response message corresponding to a negative verification response (Nack) or no IP address verification response message to the second terminal when the second local IP address is not included in the IP address list of the terminals linked to the first terminal.

According to another aspect of the present invention, there is provided a method of allocating an IP address by a second terminal, the method including: selecting a second local IP address that is a local IP address of the second terminal; maintaining a list of an IP address linked to the second terminal; receiving, from the first terminal, an IP address verification request message including a first local IP address that is a local IP address of the first terminal; verifying whether the first local IP address is included in the IP address list of the terminals linked to the second terminal or is the same as the second local IP address; and transmitting an IP address verification response message corresponding to a positive verification response (Ack) to the first terminal when the first local IP address is included in the IP address list of the terminals linked to the second terminal or is the same as the second local IP address.

The method of allocating an IP address by a second terminal may further include, when the first local IP address is not included in the IP address list of the terminals linked to the second terminal and is not the same as the second local IP address, transmitting no IP address verification response message or an IP address verification response message corresponding to a negative verification response (Nack) to the first terminal.

The method of allocating an IP address by a second terminal may further include, when the first local IP address is not included in the IP address list of the terminals linked to the second terminal and is not the same as the second local IP address and the IP address verification request message is received a predetermined number of times or more for a preset period of time, or when a message indicating use of the first local IP address is received from the first terminal, adding the first local IP address to the IP address list of the terminals linked to the second terminal to update the list.

The transmitting of the IP address verification response message corresponding to the positive verification response (Ack) to the first terminal may include stopping transmitting the IP address verification response message corresponding to the positive verification response (Ack) and changing the same IP address as the first local IP address to a different IP address when the IP address verification request message including the first local IP address is received a preset number of times or more for a preset period of time.

The changing of the same IP address as the first local IP address to the different IP address may change the second local IP address and transmit the changed local IP address to all terminals included in the IP address list of the terminals linked to the second terminal when the first local IP address is the same as the second local IP address, and request a terminal having the same IP address as the first local IP address to change the IP address when the first local IP address is included in the IP address list of the terminals linked to the second terminal.

The method of allocating an IP address by a second terminal may further include, when the first local IP address is the same as the second local IP address and a Media Access Control (MAC) address of the first terminal included in the IP address verification request message is a preset value, changing the second local IP address and transmitting the changed local IP address to all terminals included in the IP address list of the terminals linked to the second terminal.

According to still another aspect of the present invention, there is provided a first terminal which allocates an IP address including: an IP address selector to select a first local IP address that is a local IP address of the first terminal; a storage to store the first local IP address; a transmitter to transmit an IP address verification request message including the first local IP address to a second terminal; a receiver to receive an IP address verification response message indicating whether the first local IP address is included in a local IP address of the second terminal or an IP address list of the terminals linked to the second terminal; and an IP address determiner to determine whether to use the first local IP address based on the IP address verification response message.

According to yet another aspect of the present invention, there is provided a second terminal which allocates an IP address including: an IP address selector to select a second local IP address that is a local IP address of the second terminal; a storage to store the second local IP address and a list of an IP address linked to the second terminal; a receiver to receive, from the first terminal, an IP address verification request message including a first local IP address that is a local IP address of the first terminal; an IP address verification responder to verify whether the first local IP address is included in the IP address list of the terminals linked to the second terminal or is the same as the second local IP address and to generate an IP address verification response message corresponding to a positive verification response (Ack) when the first local IP address is included in the IP address list of the terminals linked to the second terminal or is the same as the second local IP address; and a transmitter to transmit the IP address verification response message to the first terminal.

As described above, an aspect of the present invention provides a technique in which each terminal autonomously selects an IP address, and verifies and adjusts availability of the IP address in coordination with another terminal linked via direct communications, thereby allocating an IP address. According to the technique, even when a particular terminal does not serve as a DHCP server, each terminal selects an IP address and allocates the IP address through verification in coordination with a terminal to communicate with, enabling each terminal to dynamically allocate an IP address.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 illustrates a device-to-device direct communication network environment in which terminals autonomously select and allocate an IP address according to an embodiment;

FIG. 2 illustrates a configuration of a terminal which dynamically allocates an IP address according to an embodiment;

FIG. 3 is a flowchart illustrating a process that a terminal transmits an IP address verification request and allocates an IP address depending on a response according to an embodiment;

FIG. 4 is a flowchart illustrating a process that a terminal receives an IP address verification request and responds regarding availability of an IP address according to an embodiment;

FIG. 5 illustrates a process of allocating an IP address when two terminals use IDs which are not duplicate in IEEE 802.15.8 peer-aware communications according to an embodiment;

FIG. 6 illustrates a process of allocating an IP address when two terminals use duplicate IDs in IEEE 802.15.8 peer-aware communications according to an embodiment;

FIG. 7 illustrates a structure of an Address Resolution Protocol (ARP) packet frame used for IP address allocation between terminals according to an embodiment;

FIG. 8 illustrates a configuration of an ARP packet corresponding to an IP address verification request message according to an embodiment;

FIG. 9 illustrates a configuration of an ACK packet of an ACK response which is an IP address verification response message corresponding to a positive verification response according to an embodiment;

FIG. 10 illustrates a configuration of an ACK packet of an ACK response corresponding to an IP address verification response message including an IP address list of a linked terminal according to an embodiment;

FIG. 11 illustrates a configuration of an ACK packet of an NACK response which is an IP address verification response message corresponding to a negative verification response according to an embodiment;

FIG. 12 illustrates a configuration of an ARP packet corresponding to an IP address use notification message according to an embodiment;

FIG. 13 illustrates a process of allocating an IP address without occurrence of an IP address collision when an IEEE 802.15.8 PAD allocates an IP address between PADs using an ARP packet in according to an embodiment;

FIG. 14 illustrates a process of resolving an IP address collision and allocating an IP address when an IEEE 802.15.8 PAD allocates an IP address between PADs using an ARP packet in according to an embodiment; and

FIG. 15 illustrates a process of allocating an IP address between IEEE 802.16.1a direct communication terminals according to an embodiment.

### DETAILED DESCRIPTION

Hereinafter, exemplary embodiments of the present invention will be described in detail with reference to the accompanying drawings, in which like reference numerals refer to like elements throughout.

Various changes and modification may be made to the following embodiments. The embodiments illustrated below are constructed not as limiting implemented forms but as including all modifications, equivalents or substitutions of the embodiments.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprise” and/or “include,” when used in this specification, specify the presence of stated features, integers, steps, operations, elements, components or combinations thereof, but do not preclude the presence or addition of one or more other features, integers, steps, operations, elements, components, or combinations thereof.

Unless otherwise defined, all terms including technical and scientific terms used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the description with reference to the accompanying drawings, the same reference numerals will be understood to refer to the same elements, and overlapping descriptions thereabout will be omitted. When it is determined detailed description related to a related known technique they may make the purpose of the embodiments unnecessarily ambiguous in describing the embodiments, the detailed description will be omitted here.

The present invention is not restricted or limited by embodiments. In the drawings, the same reference numerals will be understood to refer to the same elements.

Hereinafter, a terminal may be used to refer to a Peer Aware Device and a Peer Aware Communication Device (PAD) in the IEEE 802.15.8 standard, a direct communication terminal in the IEEE 802.16.1a standard, a High Reliability Mobile Station (HR-MS), User Equipment (UE), a Mobile MS, or the like, and these terms may be replaced with each other.

Hereinafter, a link refers to a communication channel established to enable data communications between two devices. A link may also be referred to as a connection in the IEEE 802.16 standard. Also, a link may be referred to as a peering in the IEEE 802.15.8 standard.

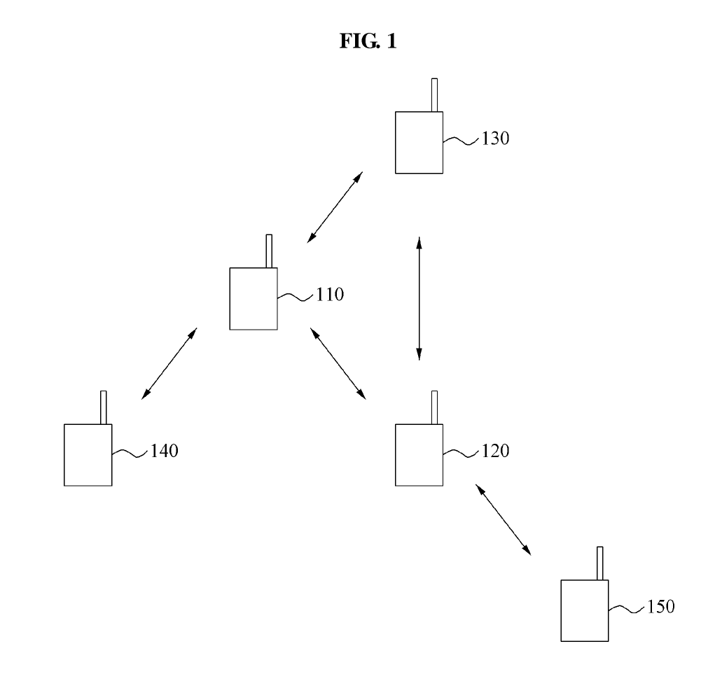

Hereinafter, a method and an apparatus for allocating an Internet Protocol (IP) address by a direct communication terminal according to an embodiment of the present invention will be described in detail with reference to FIGS. 1 to 15.

FIG. 1 illustrates a device-to-device direct communication network environment in which terminals autonomously select and allocate an IP address according to an embodiment.

In detail, FIG. 1 illustrates a wireless network environment in which a terminal allocates an IP address through verification requests and responses regarding availability of the IP address between terminals which establish a communication link by selecting a local IP address. Terminals 110, 120, 130, 140, and 150 shown in FIG. 1 may conform to the IEEE 802.15. 8 or IEEE 802.16.1a standard.

FIG. 1 illustrates an example of a direct communication environment, in which two terminals 110 and 120 establish a link, select respective local IP addresses to use, transmit the IP addresses thereof to each other, and verify the IP addresses to receive whether to use the IP addresses. A first terminal 110 has already finished link establishment and IP address use verification with a third terminal 130 and a fourth terminal 140, and a second terminal 120 has already finished link establishment and IP address use verification with the third terminal 130 and a fifth terminal 150. Subsequently, the first terminal 110 and the second terminal 120 may establish a new link and perform IP address use verification.

In the present embodiment, an IP address verification procedure refers to a process of verifying whether an IP address selected by a terminal for link establishment and data communications with a counterpart terminal is included in an IP address of the counterpart terminal and an IP address list of the terminals linked to the counterpart terminal (that is, whether the IP address is used by any one terminal). The verification procedure includes a process of verifying whether a verification-requested IP address is included in not only an IP address of a terminal receiving a verification request but also an IP address list of the terminals linked to the terminal receiving the verification request (whether the IP address is duplicate or collide with another IP address) and of responding. The terminal receiving the verification request may reply with a positive verification response (Ack) when the IP address is included in the local IP address of the terminal receiving the verification request and in the IP address list of the terminals linked to the terminal receiving the verification request. The terminal may not reply or may reply with a negative verification response (Nack) when the verification-requested IP address is duplicate and thus is not used.

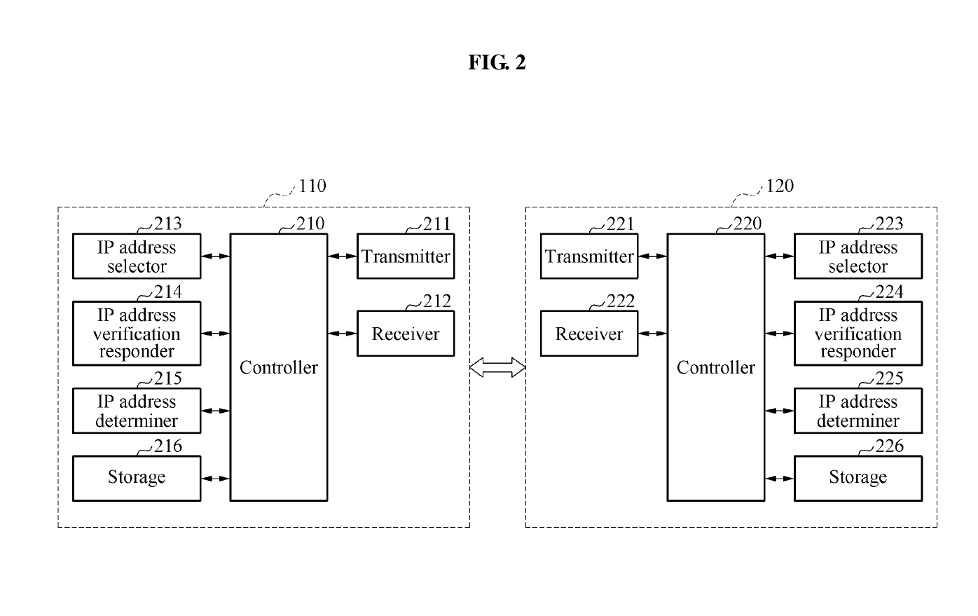

Detailed configurations of the first terminal 110 and the second terminal 120 and an operation of each component for IP address allocation will be described with reference to FIG. 2.

FIG. 2 illustrates a configuration of a terminal which dynamically allocates an IP address according to an embodiment.

Referring to FIG. 2, the first terminal 110 which requests verification of an IP address may include a controller 210, a transmitter 211, a receiver 212, an IP address selector 213, an IP address verification responder 214, an IP address determiner 215, and a storage 216.

The IP address selector 213 may select a first local IP address that is a local IP address of the first terminal 110 and store the selected first local IP address in the storage.

The IP address selector 213 may select the first local IP address using a clock counter value and a hardware identifier value of the first terminal 110.

The IP address selector 213 may store a local IP address being used when power of the first terminal 110 is turned off, and select the stored local IP address as the first local IP address when power of the first terminal 110 is turned on.

The storage 216 may store the first local IP address selected by the IP address selector 213 and store a list of an IP address linked to the first terminal 110.

The transmitter 211 transmits an IP address verification request message including the first local IP address to the second terminal 120 in order to allocate an IP address with the linked second terminal 120. Here, the transmitter 211 may transmit the IP address verification request message to the second terminal 120 after a delay of a random time since the first terminal 110 establishes a link with the second terminal 120. Further, the transmitter 211 may further include hardware identifier information on the first terminal 110 in the IP address verification request message to transmit the IP address verification request message.

The receiver 212 may receive an IP address verification response message indicating whether the first local IP address is included in a local IP address of the second terminal 120 or an IP address list of the terminals linked to the second terminal 120. The IP address verification response message may be a positive verification response (Ack) or negative identification response (Nack).

When the receiver 212 receives no IP address verification response message for a preset period of time, it is determined that an IP address verification response message corresponding to a negative verification response (Nack) is received.

The IP address determiner 215 determines whether to use the first local IP address based on the IP address verification response message. In detail, the IP address determiner 215 may determine whether to use the first local IP address based on a result of repeating transmission of the IP address verification request message including the local IP address to the second terminal 120 and reception of the IP address verification response message a first preset number of times for a first preset period of time.

The IP address determiner 215 may determine that the first local IP address is included in the IP address of the second terminal 120 or the IP address list of the terminals linked to the second terminal 120 when an IP address verification response message corresponding to the positive verification response (Ack) is received a second preset number of times for a second preset period of time.

Also, the IP address determiner 215 may determine that the first local IP address is not included in the IP address of the second terminal 120 or the IP address list of the terminals linked to the second terminal 120 when an IP address verification response message corresponding to a negative verification response (Nack) is received a third preset number of times for a third preset period of time.

Here, the first preset period of time, the second preset period of time, and the third preset period of time may be partly the same, all the same or all different, and the first preset number of times, the second preset number of times, and the third preset number of times may be partly the same, all the same or all different.

The IP address determiner 215 may set the first preset period of time and the first preset number of times in view of at least one of number of terminals linked to the first terminal 110 and number of terminals with which the first terminal 110 is establishing a link.

The IP address determiner 215 may set the first preset period of time to be longer and set the first preset number of times to be greater as a greater number of terminals are linked to the first terminal 110 and the first terminal 110 is establishing a link with a greater number of terminals.

When the IP address determiner 215 determines that the first local IP address is unavailable, the IP address selector 213 selects a new local IP address.

The transmitter 211 transmits an IP address verification request message including the new local IP address to the second terminal 120.

The IP address determiner 215 determines whether to use the new local IP address based on an IP address verification response message with respect to the new local IP address received through the receiver 212. The foregoing process may be repeated until use of the local IP address of the terminal 110 is determined.

When it is determined that the new local IP address is used for the first terminal 110, the IP address determiner 215 may transmit the new local IP address to all terminals linked to the first terminal 110 through the transmitter 211 to update the IP address of the first terminal 110.

The IP address verification responder 214 determines whether a second local IP address as the local IP address of the second terminal 120 is included in a list of an IP address linked to the first terminal 110 and responds by transmitting an IP address verification response message including a determination result to the second terminal 120 through the transmitter 211 when the received IP address verification response message is a negative verification response (Nack) and includes the second local IP address. Here, the IP address verification responder 214 transmits an IP address verification response message corresponding to a positive verification response (Ack) to the second terminal 120 when the second local IP address is included in the IP address list of the terminals linked to the first terminal 110. The IP address verification responder 214 transmits an IP address verification response message corresponding to a negative verification response (Nack) to the second terminal 120 or transmit no IP address verification response message when the second local IP address is not included in the IP address list of the terminals linked to the first terminal 110.

The controller 210 may control overall operations of the first terminal 110. The controller 210 may perform functions of the transmitter 211, the receiver 212, the IP address selector 213, the IP address verification responder 214, and the IP address determiner 215. The controller 210, the transmitter 211, the receiver 212, the IP address selector 213, the IP address verification responder 214, and the IP address determiner 215 are shown as separate components in order to distinguish the respective functions. Thus, the controller 210 may include at least one processor configured to perform the respective functions of the transmitter 211, the receiver 212, the IP address selector 213, the IP address verification responder 214, and the IP address determiner 215. Further, the controller 210 may include at least one processor configured to perform a part of the respective functions of the transmitter 211, the receiver 212, the IP address selector 213, the IP address verification responder 214, and the IP address determiner 215.

The second terminal 120, which verifies whether an allocated IP address is duplicate to respond when a request for verification of the IP address is received, may configured to include a controller 220, a transmitter 221, a receiver 222, an IP address selector 223, an IP address verification responder 224, an IP address determiner 225, and a storage 226.

The IP address selector 223 selects the second local IP address that is the local IP address of the second terminal 120. The IP address selector 223 may select the IP address in the same manner as the IP address selector 213.

The storage 226 stores the second local IP address and a list of an IP address linked to the second terminal 120.

The receiver 222 receives, from the first terminal 110, the IP address verification request message including the first local IP address that is the local IP address of the first terminal 110.

The IP address verification responder 224 generates an IP address verification response message corresponding to a positive verification response (Ack) and transmits the IP address verification response message to the first terminal 110 through the transmitter 221 when the first local IP address is included in the IP address list of the terminals linked to the second terminal 120 or is the same as the second local IP address.

The IP address verification responder 224 generates an IP address verification response message corresponding to a negative verification response (Nack) and transmits the IP address verification response message to the first terminal 110 through the transmitter 221 when the first local IP address is not included in the IP address list of the terminals linked to the second terminal 120 and is not the same as the second local IP address. Here, the IP address verification response message corresponding to the verification response (Nack) may be omitted without responding.

The transmitter 221 transmits a IP address verification response message generated by the IP address verification responder 224 to the first terminal 110 for IP address allocation with the linked second terminal 120.

The IP address determiner 225 determines that use of the first local IP address is finally determined and adds the first local IP address to the IP address list of the terminals linked to the second terminal 120 to update the IP address list of the terminals when a message indicating use of the first local IP address is received from the first terminal 110.

In addition, the IP address determiner 225 may determine that the first local IP address is finally determined when the IP address verification request message including the first local IP address which is not duplicate is received a preset number of times or more for a preset period of time. Here, the first local IP address which is not duplicate refers to an IP address which is neither included in the IP address list of the terminals linked to the second terminal 120 and is nor the same as the second local IP address.

Meanwhile, when the IP address verification request message including the first local IP address which is duplicate is received a preset number of times or more for a preset period of time, the IP address verification responder 224 determines that the first local IP address is highly likely to be used by the first terminal 110 and stops transmitting an IP address verification response message corresponding to a positive verification response (Ack), and the IP address determiner 255 changes the same IP address as the first local IP address to a different IP address.

Here, when the first local IP address is the same as the second local IP address, the IP address determiner 225 changes the second local IP address through the IP address selector 223 and transmits the changed local IP address to all terminals included in the IP address list of the terminals linked to the second terminal 120 through the transmitter 221. When the first local IP address is included in the IP address list of the terminals linked to the second terminal 120, the IP address determiner 225 may request a terminal having the same IP address as the first local IP address to change an IP address through the transmitter 221.

Meanwhile, when the first local IP address is the same as the second local IP address and a media access control (MAC) address of the first terminal 110 included in the IP address verification request message is a preset value, the IP address determiner 225 may change the second local IP address through the IP address selector 223 and transmit the changed local IP address to all terminals included in the IP address list of the terminals linked to the second terminal 120 through the transmitter 221.

The controller 220 may control overall operations of the second terminal 120. The controller 220 may perform functions of the transmitter 221, the receiver 222, the IP address selector 223, the IP address verification responder 224, and the IP address determiner 225. The controller 220, the transmitter 221, the receiver 222, the IP address selector 223, the IP address verification responder 224, and the IP address determiner 225 are shown as separate components in order to distinguish the respective functions. Thus, the controller 220 may include at least one processor configured to perform the respective functions of the transmitter 221, the receiver 222, the IP address selector 223, the IP address verification responder 224, and the IP address determiner 225. Further, the controller 220 may include at least one processor configured to perform a part of the respective functions of the transmitter 221, the receiver 222, the IP address selector 223, the IP address verification responder 224, and the IP address determiner 225.

The description of FIG. 2 focuses on the process of requesting IP address verification and allocating an IP address with reference to the components included in the first terminal 110 and on the process of verifying whether a duplicate IP address is allocated and responding upon receiving a request for IP address verification with reference to the components included in the second terminal 120. Thus, the components included in the first terminal 110 and the second terminal 120 may perform operations of components of a different terminal specified by the same names, respectively.

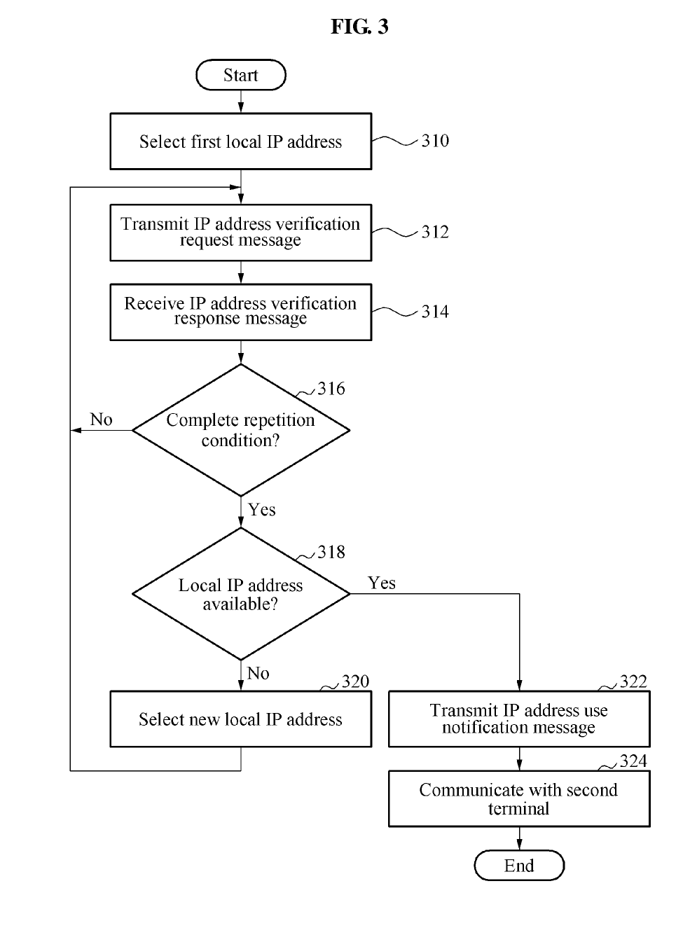

FIG. 3 is a flowchart illustrating a process that a terminal transmits an IP address verification request and allocates an IP address depending on a response according to an embodiment.

Referring to FIG. 3, the first terminal 110 selects a first local IP address that is a local IP address of the first terminal 110 in operation 310. Here, the first terminal 110 may select the first local IP address using a clock counter value and a hardware identifier value of the first terminal 110. Further, the first terminal 110 may store a local IP address being used when power of the first terminal 110 is turned off, and select the stored IP address as the first local IP address when power of the first terminal 110 is turned on.

The first terminal 110 transmits an IP address verification request message including the first local IP address to the second terminal 120 in operation 312. Here, the first terminal 110 may transmit the IP address verification request message to the second terminal 120 after a delay of a random time since the first terminal 110 establishes a link with the second terminal 120. The first terminal 110 may further include hardware identifier information on the first terminal 110 in the IP address verification request message to transmit the IP address verification request message to the second terminal 120.

The first terminal 110 may receive an IP address verification response message indicating whether the first local IP address is duplicate in operation 314. Here, regarding whether the first local IP address is duplicate, when the first local IP address is included in a local IP address of the second terminal 120 or an IP address list of the terminals linked to the second terminal 120, it is determined that the first local IP address is duplicate. In addition, when the first terminal 110 receives no IP address verification response message for a preset period of time, it may be determined that an IP address verification response message corresponding to a negative verification response (Nack) is received.

The first terminal 310 verifies whether a preset repetition condition is completed and repeats operations 312 and 314 until the repetition condition is satisfied in operation 316.

Here, the repetition condition may be a first preset number of times for a first preset period of time.

The first preset period of time and the first preset number of times may be set in view of at least one of number of terminals linked to the first terminal 110 and number of terminals with which the first terminal 110 is establishing a link. For example, the greater the number of terminals linked to the first terminal 110 are and the greater the number of terminals with which the first terminal 110 is establishing a link, the longer the first preset period of time may be set and the more the first preset number of times may be set. That is, when the selected first IP address is changed, if a substantial number of IP address changes are needed, the first preset period of time and the first preset number of times are increased to cause the second terminal 120 to change a duplicate IP address.

The first terminal 110 determines whether to use the first local IP address based on the IP address verification response message in operation 318.

The first terminal 110 may determine that the first local IP address is included in the IP address of the second terminal 120 or the IP address list of the terminals linked to the second terminal 120 when an IP address verification response message corresponding to a positive verification response (Ack) is received a second preset number of times for a second preset period of time. Further, when an IP address notification message about the same IP address as the first local IP address is received due to a change of IP address of one of other terminals having already established links with the first terminal 110 for the second preset period of time, the first terminal 110 may determine that a positive response (Ack) is received and increase the second preset number of times.

The first terminal 110 may determine that the first local IP address is not included in the IP address of the second terminal 120 or the IP address list of the terminals linked to the second terminal 120 when an IP address verification response message corresponding to a negative verification response (Nack) is received a third preset number of times for a third preset period of time.

Here, the first preset period of time, the second preset period of time, and the third preset period of time may be partly the same, all the same, or all different, and the first preset number of times, the second preset number of times, and the third preset number of times may be partly the same, all the same, or all different.

As a result of determination in operation 318, when the first local IP address is unavailable as an local IP address, the first terminal 110 selects a new local IP address, goes back to operation 312 to transmit an IP address verification request message including the new local IP address to the second terminal 120, and repeats a series of subsequent processes.

As a result of determination in operation 318, when the first local IP address is available as an local IP address, the first terminal 110 transmits, to the second terminal 120, an IP address use notification message indicating that the local IP address is finally used in operation 322.

When the IP address included in the IP address use notification message transmitted in operation 322 is not the first local IP address selected in operation 310 but the new local IP address selected in operation 320, the first terminal 110 transmits the new local IP address to all terminals linked to the first terminal 110 to update the IP address of the first terminal 110.

The first terminal 110 communicates with the second terminal 120 using the allocated IP address in operation 324.

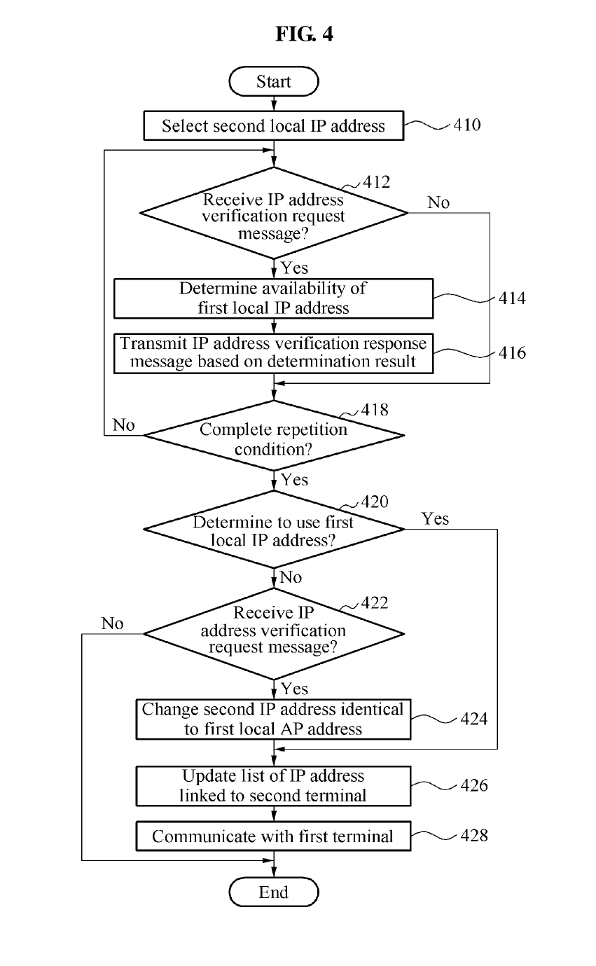

FIG. 4 is a flowchart illustrating a process that a terminal receives an IP address verification request and responds regarding availability of an IP address according to an embodiment.

Referring to FIG. 4, the second terminal 120 selects a second local IP address that is a local IP address of the second terminal 120.

When an IP address verification request message including the first local IP address that is the local IP address of the first terminal 110 is received from the first terminal 110 in operation 412, the second terminal 120 verifies whether the first local IP address which is duplicate is used to determine availability of the first local IP address in operation 414. Here, when the first local IP address is included in an IP address list of the terminals linked to the second terminal 120 or is the same as the second local IP address, it is determined that the first local IP address is duplicate.

The second terminal 120 may transmit, to the first terminal 110, an IP address verification response message including a result of verifying (determining) whether the first local IP address is duplicate in operation 416. Here, the second terminal 120 may transmit an IP address verification response message corresponding to a positive response (Ack) to the first terminal 110 when the first local IP address is duplicate. The second terminal 120 may not transmit an IP address verification response message or may transmit an IP address verification response message corresponding to a negative response (Nack) to the first terminal 110 when the first local IP address is not duplicate.

The second terminal 120 verifies whether a preset repetition condition is completed and repeats operations 412 to 416 until the repetition condition is satisfied in operation 418. Here, the repetition condition may be a first preset number of times for a first preset period of time.

The second terminal 120 verifies whether use of the first local IP address is determined in operation 420. In determining whether to use the first local IP address, when a message indicating use of the first local IP address is received from the first terminal 110 or an IP address verification request message including the first local IP address which is not duplicate is received a preset number of times or more for a preset period of time, it is determined to use the first local IP address.

As a result of verification in operation 420, when it is determined that the first local IP address is not used, the second terminal 120 may verify whether the IP address verification request message is received in operation 422.

As a result of verification in operation 422, when the IP address verification request message including the first local IP address is received (that is, when the IP address verification request message including the first local IP address which is duplicate is received over a preset number of times for a preset period of time, reception of an IP address notification message including the duplicate first local IP address is determined as an IP address verification request message to be included in a count of the preset number of times for the preset period of time), in operation 424, the second terminal 120 changes the second IP address identical to the first local IP address to a different IP address.

Here, when the first local IP address is the same as the second local IP address in operation 424, the second terminal 120 may change the second local IP address and transmit the changed local IP address to all terminals included in the IP address list of the terminals linked to the second terminal 120. Further, when the first local IP address is included in the IP address list of the terminals linked to the second terminal 120 in operation 424, the second terminal may request a terminal having the same IP address as the first local IP address to change an IP address.

The second terminal 120 adds the first local IP address to the IP address list of the terminals linked to the second terminal 120 to update the list in operation 426.

The second terminal 120 communicates with the first terminal 110 using the allocated IP address in operation 428.

Meanwhile, as a result of verification in operation 420, when it is determined that the first local IP address is used, the second terminal 120 goes to operation 426 and conduct a series of subsequent operations.

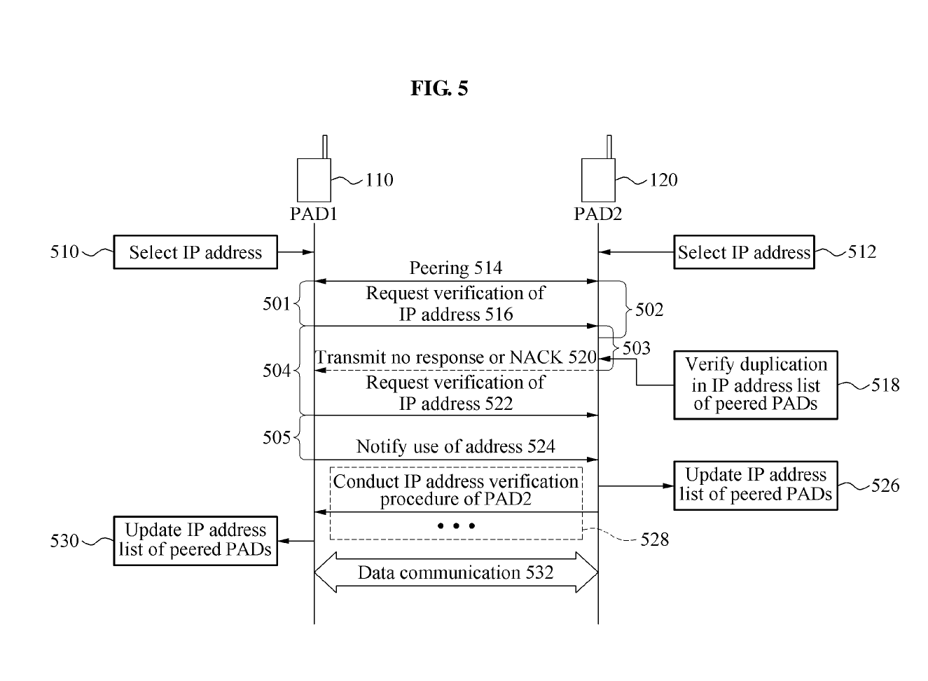

FIG. 5 illustrates a process of allocating an IP address when two terminals use IDs which are not duplicate in IEEE 802.15.8 peer-aware communications according to an embodiment.

According to the IEEE 802.15. 8 standard, the term “terminal” is referred to as peer aware communication device (PAD) and the term “link” is referred to as peer.

In FIG. 5, not using a duplicate ID address means that an IP address for one PAD to select for use is not included in an IP address used by a counterpart PAD and in an IP address list of PADs peered to the counterpart PAD.

Referring to FIG. 5, when PAD1 110 selects an IP address in operation 510, PAD1 110 may select an IP address for use in a local IP address range, verify availability of the IP address, and allocate the IP address, instead of being allocated the IP address by a server. The local IP address range is an IP address range used for a local network, which may be an address range from 169.254.1.0 to 169.254.254.255 in IP version 4 and be a fe80::/10 range (a range of remaining addresses with first 10 bits fixed) in IP version 6. In a selection process, a random IP value may be selected in the local address range using a hardware identifier (HW ID) and a clock value of PAD1 110 as random seed values. Further, in the selection process, an 32-bit IP value may be selected using the HW ID (for example, 48-bit MAC address) and a hash function.

PAD1 110 may store an IP address used when power is turned off, and select the stored IP address when power is turned on. PAD2 120 may select an IP address for use in the same manner in operation 512.

When a PAD search and a peering procedure in operation 514 are finished, a channel for data transmission is open and PAD1 110 and PAD2 120 have a peering identifier (PID) to distinguish the channel PAD1 110 and PAD2 120 transmit IP address verification requests to the PADs in order to verify the respectively selected IP addresses. The IP address verification requests may further include PAD HW IDs of the respective PADs.

PAD1 110 and PAD2 120 transmit the IP address verification requests after a delay of a random time 501 since peering and after a delay of a random time 502, respectively. PAD1 110, which has the delay of the random time 501 shorter than the delay of the random time 502 of PAD 120, transmits the verification request first, thereby avoiding a collision between PAD1 110 and PAD2 120.

PAD2 120, which selects a delay of a relatively long random time and thus first receives the IP address verification request 516 from PAD1 110, may process the request and then transmit the IP address verification request to PAD1 110. Alternatively, PAD2 120 may transmit the IP address verification request independently of the IP address verification request by PAD1 110. That is, PAD2 120, which receives an IP address use verification request, may transmit an IP address use verification request of PAD2 120 after or simultaneously with an address verification procedure of PAD1 110.

When PAD1 110 and PAD2 120 verify the counterpart IP addresses, PAD1 110 and PAD2 120 update IP address lists of the PADs peered to PAD1 110 and PAD2 120, respectively, in operations 526 and 530. A PAD receiving an IP address verification request may verify that a requested IP address is not included in an IP address of the PAD and an IP address list peered to the PAD and update the IP address list of the PAD. In addition, the PAD receiving the IP address verification request may map the requested local IP address onto an HW ID of a PAD requesting IP address verification and store the local IP address in an IP address list of peered PADs.

When there is no response within a predetermined period of time 503 or a non-acknowledgement (NACK) is received in operation 520 after the IP address use verification request is transmitted to PAD2 120, PAD1 110 may repeat a request for IP address verification a predetermined number of times at predetermine time intervals 504 in operation 522. When there is no response to the repeated IP address use verification requests, PAD1 110 may report IP address use verification after a predetermine period of time 505 in operation 524.

When acknowledgement (ACK) information indicating that the requested IP address is used is received from PAD2 120 over a predetermined number of times for a predetermined period of time, PAD1 110 determines that the local IP address is unavailable and selects a random IP address in the local IP address range excluding the IP address list of the peered PADs to PAD1 110 and the requested IP address. PAD1 110 transmits the selected IP address to PAD2 120 and requests IP address use verification. When no response or an NACK is received from PAD2 120, PAD1 110 verifies that the requested IP address is available. In this case, the IP address being used by PAD1 110 is changed to avoid duplication in a verification process with new PAD2 120. After verification, if there are previously peered PADs, PAD1 110 may transmit the changed IP address to all PADs.

PAD2 120 finishes peering with PAD1 110 after a PAD search. When an IP address verification request is received from PAD1 110 within the delay of the random time 502 for transmission of the IP address verification request, PAD2 120 verifies whether the requested IP address is included in an IP address used by PAD2 120 and an IP address list of the peered PADs to check duplication of the IP address in operation 518. When the IP address verification-requested by PAD1 110 is included, that is, is duplicate, PAD2 120 may transmit an ACK response. That is, when the verification-requested IP address from PAD1 110 is included in the IP address used by PAD2 120 and an IP address list of the PADs peered to PAD2 120, that is, there is the same IP address as the requested IP address, PAD2 120 may transmit an ACK response indicating that the IP address is used.

The ACK response may include the IP address list of the peered PADs. When the requested IP address is not included in the IP address list of the peered PADs, PAD2 120 may transmit no response or an explicit NACK response. The IP address list of the PADs peered to PAD2 120 may be updated to include the requested IP address in operation 526.

PAD2 120 may conduct an IP address verification procedure for IP address allocation in the same manner as in the IP allocation procedure after verification of the IP address of PAD1 110 in operation 528. When a two-way data channel is established between PAD1 110 and PAD2 120, each IP address verification procedure may be conducted independently.

Then, PAD1 110 and PAD120 perform data communications in operation 532.

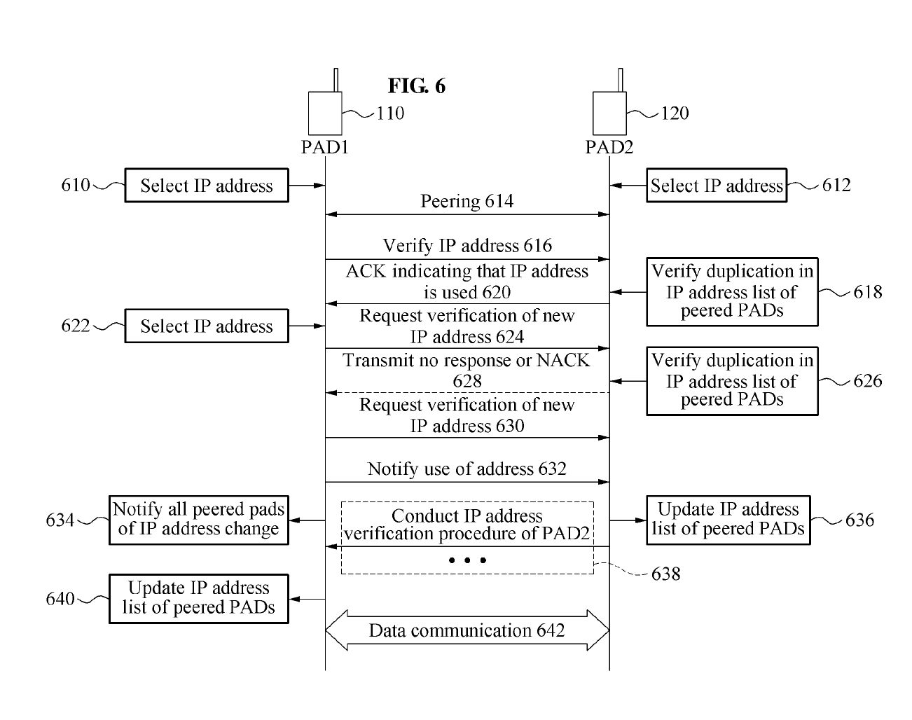

FIG. 6 illustrates a process of allocating an IP address when two terminals use duplicate IDs in IEEE 802.15.8 peer-aware communications according to an embodiment.

FIG. 6 further illustrates an operation of resolving use of a duplicate IP address or an IP address collision in addition to the process of FIG. 5.

PAD1 110 and PAD2 120 may each select an IP address to conduct a verification procedure for mutual data communications in operations 610 and 612. PAD1 110 and PAD2 120 finish a PAD search and peering in operation 614 and select a delay of a random time to conduct an IP address verification request in operation 616. In FIG. 6, PAD1 110 selects a delay of a shorter random time than that of PAD2 120 and transmits an IP address request first. When a one-way data channel is established after peering, PAD1 110 which selects the delay of the shorter random time performs an IP address verification request first and PAD2 120 which selects a delay of a longer random time performs an IP address verification request later.

When there is no PAD peered to PAD1 110, PAD1 110 may transmit a verification request to PAD2 120 in order to use a selected random IP address or an IP address stored when power is turned off. When there is an already peered PAD which uses an allocated IP address, PAD1 110 transmits the IP address to PAD2 120 for an IP address verification request in operation 616.

PAD2 120, which receives the IP address verification request from PAD1 110, determines whether an IP address verification-requested by PAD1 110 is included in an IP address of PAD2 120 and an IP address list of the peered PADs in operation 618. When the requested IP address is included, PAD2 120 may transmit an ACK response within a certain period of time in operation 620 to indicate that the IP address is used.

When the ACK response indicating that the requested IP address is used is received from PAD2 120 over a predetermined number of times, PAD1 110 selects an IP address in a local IP address range excluding the requested IP address and an IP address list of the PADs peered to PAD1 110 in operation 622.

PAD1 110 transmits an IP address verification request to PAD2 120 in operation 624 in order to use the newly selected IP address and waits for a response. PAD2 120, which receives the IP address verification request from PAD1 110, verifies duplication of the IP address in operation 626. When the IP address is not included in the IP address of PAD2 120 and the IP address list of the peered PADs, PAD2 120 may transmit no response or an explicit NACK response to indicate that the IP address is available in operation 628. When no response is received for a predetermined period of time or an NACK is received within a predetermined period of time, PAD1 110, which transmits the IP address verification request, determines that the new IP address is available and notify PAD2 120 of use of the IP address in operation 632. PAD1 110, which receives no response or an NACK to the IP address verification request, may transmit a request for verification of the new IP address once again to PAD2 120 for notification of use of the IP address in operation 630.

When it is determined that the first requested IP address by PAD1 110 is used so that the new IP address is verified, if there is a PAD peered to PAD1 110, the changed IP address is notified to all PADs in operation 634.

PAD2 120, which receives an IP address use notification, adds the IP address to a PAD IP address list of PAD2 120 to update the list in operation 636. PAD2 120 transmits no response for the predetermined period of time or an NACK response within the predetermined period of time to the IP address verification request from PAD1 110, and then may determine that the IP address use notification is received and update the PAD IP address list of PAD2 120 if an IP address verification request is received from PAD1 110 within a predetermined period of time.

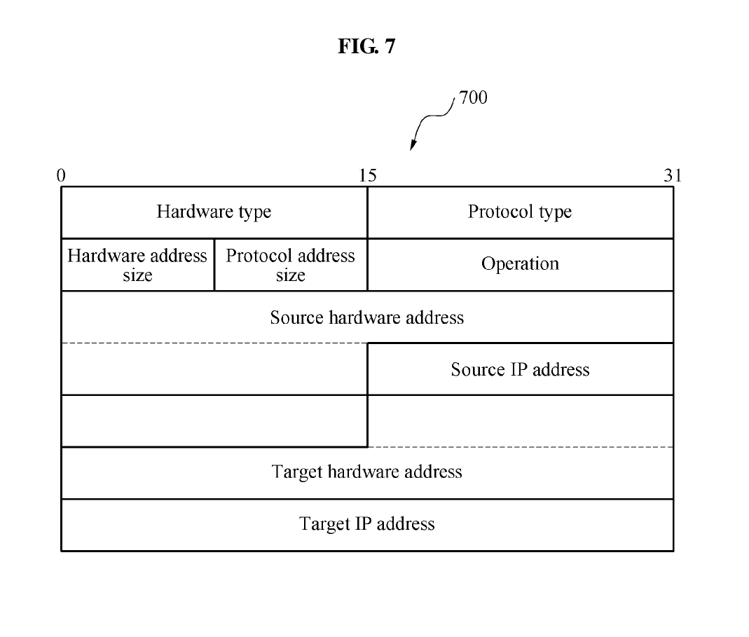

FIG. 7 illustrates a structure of an Address Resolution Protocol (ARP) packet frame used for IP address allocation between terminals according to an embodiment.

Referring to FIG. 7, an IP address verification request, an ACK response, a linked terminal IP address list ACK response, an NACK response, and an IP address use notification may be performed using the ARP frame 700.

Each field of the ARP frame 700 is described below.

Hardware type: value representing a network type, which is 0x0006 for an IEEE 802 network.

Protocol type: value representing a protocol type, which is 0x0806 for an ARP packet.

Hardware Address size: value representing MAC address length, which is 6 bytes for the IEEE 802 network.

Protocol Address size: value representing protocol address length, which is 4 bytes for IP version 4.

Operation: value representing a packet type, which is 1 for ARP request and 2 for ARP response (ACK or NACK).

Source Hardware Address: MAC address of a sender.

Source Protocol Address: IP address of a sender.

Target Hardware Address: MAC address of a destination.

Target Protocol Address: IP address of a destination

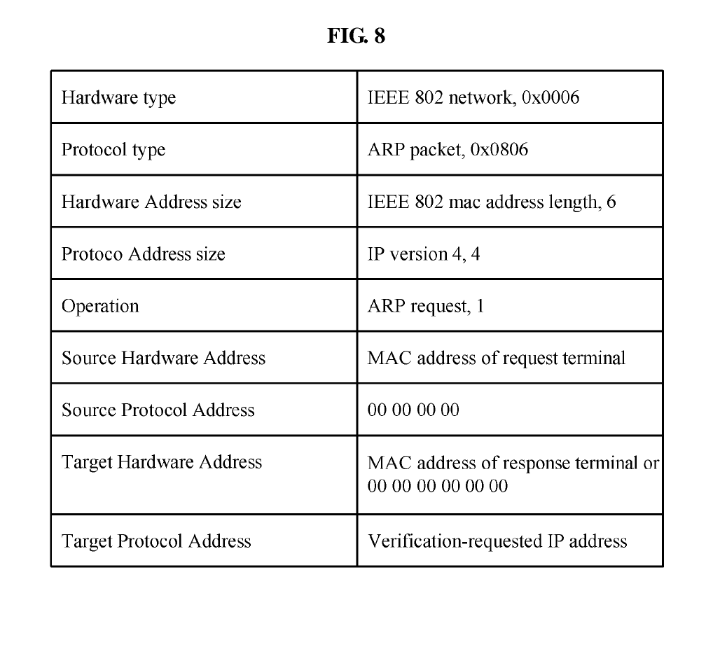

Embodiments of using an ARP packet frame used for allocating an IP address in communications between terminals in accordance with the IEEE 802.15.8 standard, IEEE 802.16 standard or IEEE 802.11 standard will be described with reference to FIGS. 8 to 14.

FIG. 8 illustrates a configuration of an ARP packet corresponding to an IP address verification request message according to an embodiment.

Referring to FIG. 8, a field value of 0x0006 for an IEEE 802 network may be used, and a verification-requested IP address, such as an HW ID (MAC address) of a request terminal, may be transmitted via a Target Protocol Address field.

A terminal receiving an IP address verification terminal may determine the verification-requested IP address in the Target Protocol Address field and transmit an ACK response, no response or an NACK response. The terminal receiving the request may transmit an ACK response indicating that the verification-requested IP address is included in an IP address of the terminal receiving the request and an IP address list of a linked terminal to be used. The terminal receiving the request may transmit no response or an NACK response indicating that the IP address is not included and used by explicitly including an IP address of a response terminal in a Source Protocol Address.

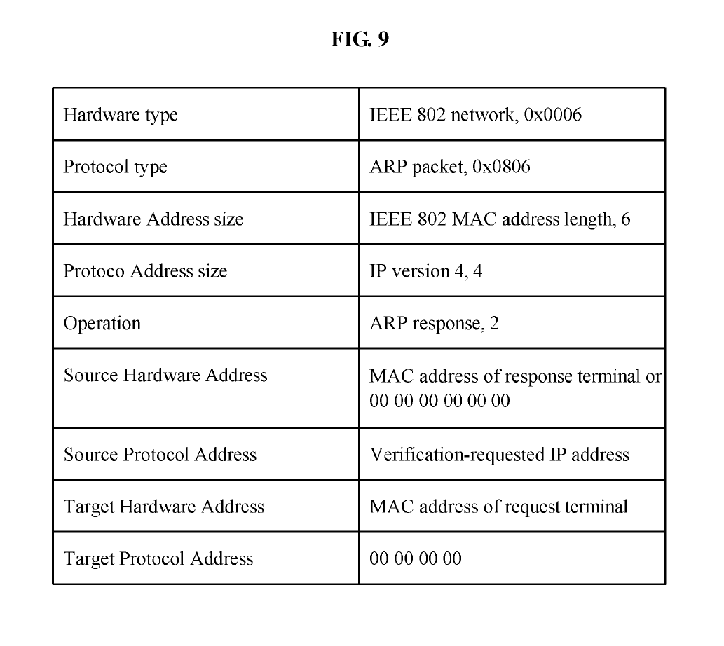

FIG. 9 illustrates a configuration of an ACK packet of an ACK response which is an IP address verification response message corresponding to a positive verification response according to an embodiment.

Referring to FIG. 9, the response is transmitted by using an MAC address or broadcast address (00 00 00 00 00 00) of a response terminal in a Source Hardware Address field and a verification-requested IP address in a Source Protocol Address field. The response terminal may respond using the MAC address or broadcast address of the response terminal in the Source Hardware Address field to indicate that the IP address is duplicate with an IP address in an IP address list of the terminals linked to the response terminal.

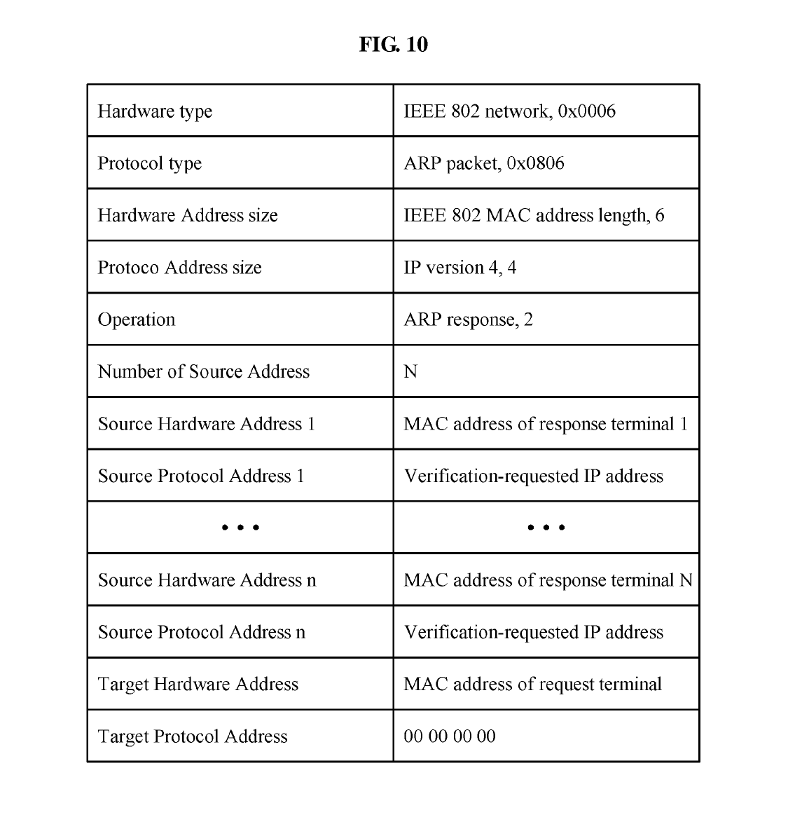

FIG. 10 illustrates a configuration of an ACK packet of an ACK response corresponding to an IP address verification response message including an IP address list of a linked terminal according to an embodiment.

Referring to FIG. 10, the ARP packet of the ACK response may be transmitted, further including a Number of Source Address field and a list of as many Source Hardware Address and Source Protocol Address pairs as a list of IP addresses of response terminals and IP addresses of linked terminals.

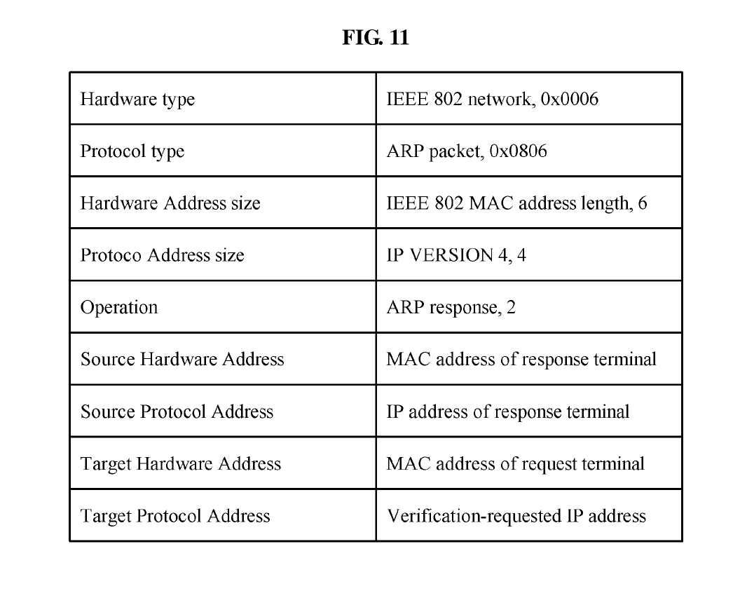

FIG. 11 illustrates a configuration of an ACK packet of an NACK response which is an IP address verification response message corresponding to a negative verification response according to an embodiment.

Referring to FIG. 11, a response terminal may make an IP address verification request of the response terminal using an NACK response instead. The response terminal may include an IP address of the response terminal in a Source Protocol Address field at transmission to additionally transmit the IP address verification request. When the NACK response is received, a request terminal may determine whether the IP address is included in an IP address list of the terminals linked to the request terminal. When the IP address is included in the list, the request terminal may transmit an ACK. The response terminal receiving the ACK may select a new IP address and transmit an IP address verification request.

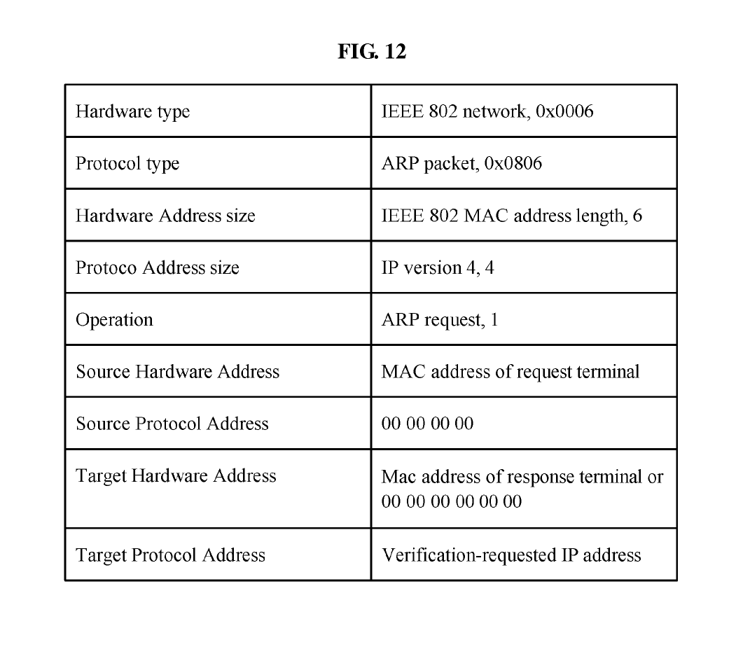

FIG. 12 illustrates a configuration of an ARP packet corresponding to an IP address use notification message according to an embodiment.

Referring to FIG. 12, when a terminal transmitting an IP address verification request determines that an IP address is available based on an ACK response, no response or an NACK response to the IP address verification request from a response terminal, the terminal may transmit an ARP packet indicating an IP address use notification. The terminal may transmit the IP address use notification by inputting an MAC address or broadcast address of the response terminal in a Target Hardware Address field and inputting a verification-verified IP address in a Target Protocol Address field.

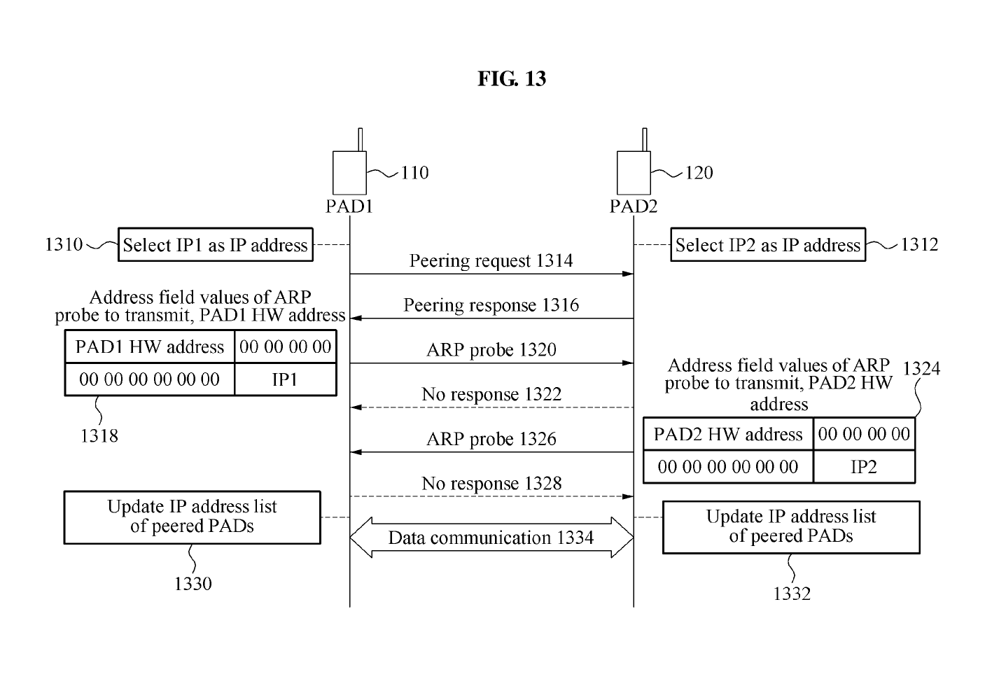

FIG. 13 illustrates a process of allocating an IP address without occurrence of an IP address collision when an IEEE 802.15.8 PAD allocates an IP address between PADs using an ARP packet in according to an embodiment.

In FIG. 13, an IP address collision means that when one PAD requests verification of an IP address, the IP address is included in an IP address of a response PAD and in an IP address list of the PADs peered to the response PAD.

Referring to FIG. 13, PAD1 110 and PAD2 120 select an IP address for use in operations 1310 and 1312. The IP address selected for use may be one of a random address selected from local IP addresses, an IP address selected at random using a clock counter value and an HW ID of a PAD as random variable selection seeds, an IP address being used with a currently peered PAD, and an IP address stored when power is turned off.

PAD1 110 and PAD2 120 conduct a counterpart PAD search and perform peering by transmitting a peering request in operation 1314 and receiving a peering response in operation 1316.

PAD1 110 and PAD2 120 may transmit an ARP probe packet for an IP address verification request after a delay of a random time in order to request IP address verification.

Referring to FIG. 13, PAD1 110 transmits an ARP probe packet after a delay of a shorter random time to conduct an IP address verification procedure first. Fields 1318 of an ARP probe may be configured to include an HW address of PAD1 110 requesting address verification in a Source Hardware Address field, 00 00 00 00 in a Source Protocol Address field, 00 00 00 00 00 00 in a Target Hardware Address field, and an address value of IP1 selected by PAD1 110 in a Source Protocol Address field.

FIG. 13 does not show an Operation field of a transmitted ARP probe 1320 which is set to 1 to indicate an ARP request and an Operation field of an ARP response which is set to 2 to indicate an ARP response.

PAD2 120, which receives the ARP probe for an IP address verification request from PAD1 110, determines whether the IP address is included in IP2 selected by PAD2 120 and in an IP address list of the PADs peered to PAD2 120. When the IP address is not included, PAD2 120 transmits no response in operation 1322.

PAD2 120 generates an ARP probe having ARP probe fields 1324 using selected IP2 to transmit an IP address verification request to PAD1 110 in operation 1326. PAD1 110, which receives the ARP probe, determines whether the IP address is included in IP1 selected by PAD1 110 and an IP address list of the PADs peered to PAD1 110. When the IP address is not included, PAD1 110 transmits no response in operation 1328.

After performing IP address verification, the PADs update the IP address lists of the peered PADs in operations 1330 and 1332, respectively. Each IP address list of the peered PADs may be updated by mapping a PAD HW address in the ARP packet to the IP address. Alternatively, the IP address list of the peered PADs may be stored by mapping a peering ID, which is allocated to peering that is finished, to the IP address.

PAD1 110 and PAD2 120 perform data communications using the allocated IP addresses in operation 1334.

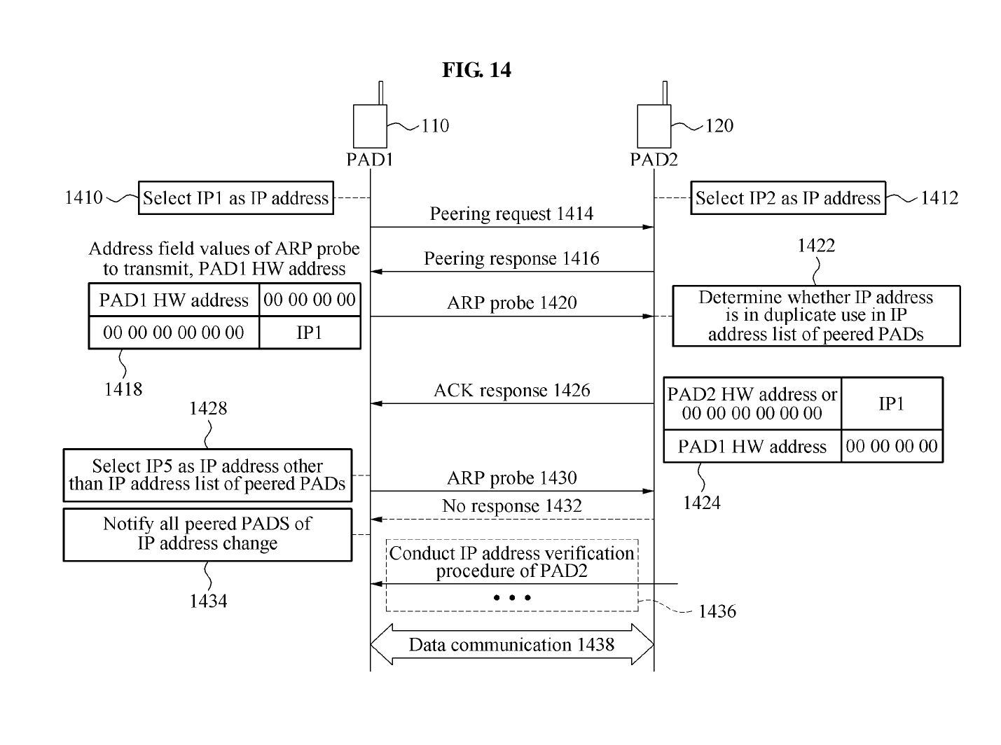

FIG. 14 illustrates a process of resolving an IP address collision and allocating an IP address when an IEEE 802.15.8 PAD allocates an IP address between PADs using an ARP packet in according to an embodiment.

In FIG. 14, an IP address collision means that when one PAD transmits an ARP probe for requesting verification of an IP address, the IP address is included in an IP address of a response PAD receiving the ARP probe the IP address and in an IP address list of the peered PADs. The response PAD transmits an ACK ARP response indicating that the requested IP address is in duplicate use, and the request PAD receiving the ACK ARP response may select a new IP address to conduct a verification procedure.

Referring to FIG. 14, PAD1 110 and PAD2 120 to be peered for communications each select an IP address in operations 1410 and 1412. After peering is completed in operations 1410 and 1416, PAD1 110, which selects a delay of shorter random time than that of PAD2 120, transmits an ARP probe for IP address verification to PAD2 120 first in operation 1420. Fields 1418 of an ARP probe packet are configured to include an HW address of PAD1 110 in a Source Hardware Address field, 00 00 00 00 in a Source Protocol Address field, 00 00 00 00 00 00 in a Target Hardware Address field, and IP1 as a verification-requested IP address in a Target Protocol Address field.

PAD2 120 receiving the ARP probe packet determines whether a selected address value of IP2, which is not directly duplicate with IP1, is included in an IP address list of the PADs peered to PAD2 120 to check duplication of the address and transmits an ARP response packet 1426 as an ACK response within a predetermined period of time in operation 1426. Fields 1424 of the ARP response packet may be configured to include an HW address of PAD2 120 or 00 00 00 00 00 00 in a Source Hardware Address field, IP1 in a Source Protocol Address field, an HW address of PAD1 110 in a Target Hardware Address field, 00 00 00 00 in a Target Protocol Address field.

A Source Hardware Address value of 00 00 00 00 00 00 in the ARP response packet may be used to indicate that the requested IP address is included in the IP address list of the peered PADs.

PAD1 110 receiving the ARP response packet 1426 determines that the requested IP address is unavailable, selects IP5 as an IP address to use in a range other than the IP address list of the PADs peered to PAD1 110 in operation 1428, and transmits an ARP probe for an IP address verification request in operation 1430. PAD2 120 receiving the ARP probe for requesting verification of IP5 determines whether IP5 is included, and transmits no response since IP5 is not included in operation 1432. When no response is received for a certain period of time, PAD1 110 determines that IP5 is available and allocates IP5 to PAD1 110 for use.

PAD1 110 transmits the ARP probe for requesting verification of IP5 to all PADs peered to PAD1 110 to notify all PADs that the IP address of PAD1 110 is changed to IP5 in operation 1434. A PAD peered to PAD1 110 performs an address verification procedure to verify the new IP address when the ARP probe for requesting verification of the new address IP5 is received from PAD1 110. The PAD determines whether IP5 address is included in an IP address list of the PADs peered to PAD1 110, and transmits an ARP response that is an ACK response to indicate that IP5 is not available for PAD1 110 if IP5 is included. PAD1 110 repeats IP address verification, response determination, and changed IP address notification procedures until an IP address which undergoes an address collision is selected and allocated.

PAD2 120 transmits an IP address verification request in the same manner as in the IP address verification procedure. PAD2 120 determines a response to the IP address verification request, selects and verifies a new IP address when an IP address collision occurs, and notify all peered PADs of the changed IP address to conduct an address change verification in operation 1436.

PAD1 110 and PAD2 120 perform data communications using the allocated IP addresses in operation 1438.

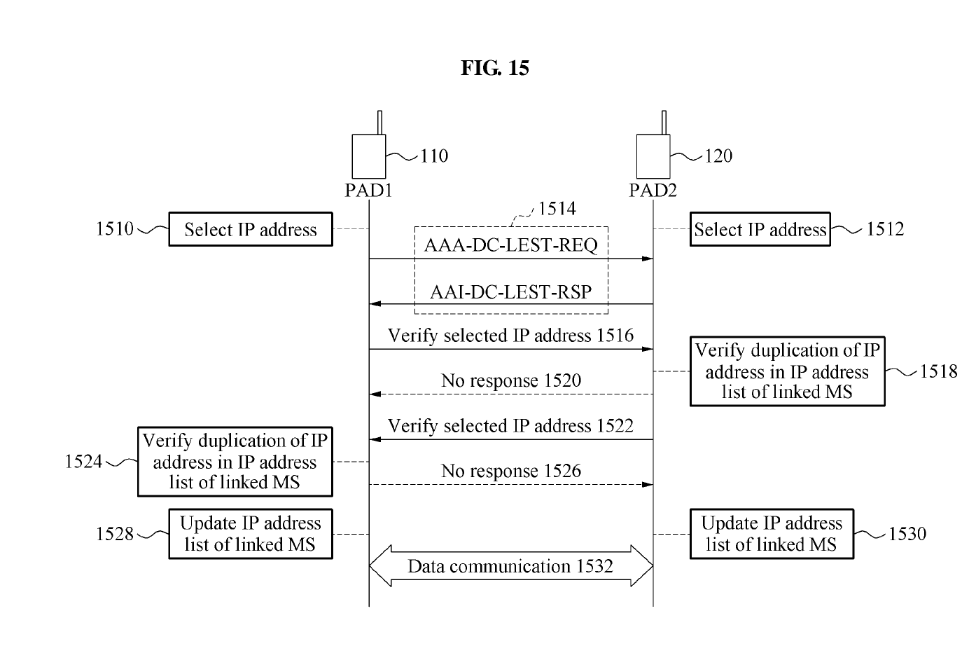

FIG. 15 illustrates a process of allocating an IP address between IEEE 802.16.1a direct communication terminals according to an embodiment.

In FIG. 15, according to the IEEE 802.16.1a standard, the term “direct communication terminal” is referred to as mobile station (MS).

Referring to FIG. 15, MS1 110 and MS2 120 select IP addresses, respectively, in operations 1510 and 1512.

A direct communication link is established between MS1 110 and MS2 120 in operation 1514. When a direct communication link is established, the link is allocated a link ID to distinguish the link. To establish a link between MSs in accordance with the IEEE 802.16.1a standard, an Advanced Air Interface-Direct Communication-Link Establishment-Request (AAI-DC-LEST-REQ) message and an Advanced Air Interface-Direct Communication-Link Establishment-Response (AAI-DC-LEST-RSP) message are exchanged in operation 1514. A single one-way link is established by exchanges of these messages. The established link is distinguished by an ID for identifying the link. To establish a two-way link, a separate link is further established. In the present embodiment, a one-way link is considered. Through the one-way link, data may be transmitted in one direction at one time, and the direction may be changed to an opposite direction as requested, which is not illustrated in FIG. 15.

According to the IEEE 802.16.1a standard, an MS transmitting a link setup message may make an IP address verification request first. In an IEEE 802.16.1a one-way link, the MS making a link setup request conducts transmission first is, thus avoiding a collision between IP address verification requests. MS1 110 transmits an address verification request for a selected IP address to MS2 120 in operation 1516. MS2 120 receiving the IP address verification request from MS1 110 determines whether the selected IP address is included in an IP address of MS2 120 and in an IP address list of an MS linked MS2 120 to determine duplication of the IP address in operation 1518. When the verification-requested IP address is not used, MS2 120 may transmit no response to indicate that the IP address is available in operation 1520 and adds the IP address to the IP address list of the linked MS to update the list in operation 1530. When no response is received for a certain period of time after transmitting the IP address verification request, MS1 110 determines that the IP address is available and allocates and use the IP address.

MS2 120 also transmits an address verification request for a selected IP address to MS1 110 in operation 1522. MS1 110 receiving the IP address verification request determines whether the selected IP address is included in an IP address of MS1 110 and in an IP address list of an MS linked MS1 110 to determine duplication of the IP address in operation 1524. When the IP address is not used, MS1 110 may transmit no response to indicate that the IP address is available in operation 1526 and adds the IP address to the IP address list of the linked MS to update the list in operation 1528. When no response is received for a certain period of time after transmitting the IP address verification request, MS2 120 determines that the IP address is available and allocates and use the IP address.

MS1 110 and MS2 120 conduct data communications using the allocated IP addresses in operation 1532. When the established link is released after data communications, the IP addresses are deleted from the IP address lists of the MSs to update the lists.

The method for allocating an Internet Protocol (IP) address by a direct communication terminal according to the above-described exemplary embodiment of the present invention may be recorded in computer-readable media including program instructions to implement various operations embodied by a computer. The media may also include, alone or in combination with the program instructions, data files, data structures, and the like. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. The media may also be a transmission medium such as optical or metallic lines, wave guides, and the like, including a carrier wave transmitting signals specifying the program instructions, data structures, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

Although the present invention has been described with reference to specific details including concrete configurations, a few exemplary embodiments, and the drawings, which are provided merely for an overall understanding of the present invention, the present invention is not limited to the described exemplary embodiments. Instead, it would be appreciated by those skilled in the art that changes may be made to these exemplary embodiments without departing from the principles and spirit of the invention.

Therefore, the scope of the present invention is not limited to the foregoing exemplary embodiments but is defined by the claims, their equivalents, and equivalent modifications.

What is claimed is:

1. A method of allocating an Internet Protocol (IP) address by a first terminal, the method comprising:
selecting a first local IP address that is a local IP address of the first terminal;
transmitting an IP address verification request message comprising the first local IP address to a second terminal;
receiving an IP address verification response message indicating whether the first local IP address is comprised in a local IP address of the second terminal or an IP address list of terminals linked to the second terminal; and
determining whether to use the first local IP address based on the IP address verification response message.

2. The method of claim 1, wherein the selecting of the first local IP address selects the first local IP address by using a clock counter value and a hardware identifier value of the first terminal.

3. The method of claim 1, wherein the selecting of the first local IP address stores a local IP address used when power of the first terminal is turned off, and selects the stored local IP address as the first local IP address when power of the first terminal is turned on.

4. The method of claim 1, wherein the transmitting of the IP address verification request message to the second terminal transmits the IP address verification request message to the second terminal after a delay of a predetermined time since a link to the second terminal is established.

5. The method of claim 1, wherein the transmitting of the IP address verification request message to the second terminal transmits the IP address verification request message to the second terminal by further comprising hardware identifier information on the first terminal in the IP address verification request message.

6. The method of claim 1, wherein the receiving of the IP address verification response message determines that an IP address verification response message corresponding to a negative verification response (Nack) is received when the IP address verification response message is not received for a preset period of time.

7. The method of claim 1, wherein the transmitting of the IP address verification request message comprising the local IP address to the second terminal and the receiving of the IP address verification response message are repeated a first preset number of times for a first preset period of time,
the determining of whether to use the first local IP address determines that the first local IP address is comprised in the IP address of the second terminal or the IP address list of the terminals linked to the second terminal when the IP address verification response message corresponding to a positive verification response (Ack) is received a second preset number of times for a second preset period of time, and determines that the first local IP address is not comprised in the IP address of the second terminal or the IP address list of the terminals linked to the second terminal when the IP address verification response message corresponding to a negative verification response (Nack) is received a third preset number of times for a third preset period of time,
the first preset period of time, the second preset period of time, and the third preset period of time are partly the same, all the same, or all different, and
the first preset number of times, the second preset number of times, and the third preset number of times are partly the same, all the same, or all different.

8. The method of claim 7, wherein the first preset period of time and the first preset number of times are set in view of at least one of number of terminals linked to the first terminal and number of terminals with which the first terminal is establishing a link.

9. The method of claim 1, further comprising performing communication with the second terminal using the first local IP address when the first local IP address is available as a result of the determining of whether to use the first local IP.

10. The method of claim 1, further comprising, when the first local IP address is unavailable as a result of the determining of whether to use the first local IP address, transmitting an IP address verification request message comprising a new local IP address to the second terminal and receiving an IP address verification response message with respect to the new local IP address to determine whether to use the new local IP address.

11. The method of claim 10, further comprising, when it is determined that the new local IP address is used for the first terminal, transmitting, by the first terminal, the new local IP address to all terminals linked to the first terminal to update the IP address of the first terminal.

12. The method of claim 1, further comprising, when the received IP address verification response message is a negative verification response (Nack) and comprises a second local IP address that is the local IP address of the second terminal, determining whether the second local IP address is comprised in an IP address list of the terminals linked to the first terminal; and responding to the second terminal depending on a determination result,
wherein the responding to the second terminal transmits an IP address verification response message corresponding to a positive verification response (Ack) to the second terminal when the second local IP address is comprised in the IP address list of the terminals linked to the first terminal, and transmits an IP address verification response message corresponding to a negative verification response (Nack) or no IP address verification response message to the second terminal when the second local IP address is not comprised in the IP address list of the terminals linked to the first terminal.

13. A method of allocating an Internet Protocol (IP) address by a second terminal, the method comprising:
selecting a second local IP address that is a local IP address of the second terminal;
maintaining an IP address list of terminals linked to the second terminal;
receiving, from the first terminal, an IP address verification request message comprising a first local IP address that is a local IP address of the first terminal;
verifying whether the first local IP address is comprised in the IP address list of the terminals linked to the second terminal or is the same as the second local IP address; and
transmitting an IP address verification response message corresponding to a positive verification response (Ack) to the first terminal when the first local IP address is comprised in the IP address list of the terminals linked to the second terminal or is the same as the second local IP address.

14. The method of claim 13, further comprising, when the first local IP address is not comprised in the IP address list of the terminals linked to the second terminal and is not the same as the second local IP address, transmitting no IP address verification response message or an IP address verification response message corresponding to a negative verification response (Nack) to the first terminal.

15. The method of claim 13, further comprising, when the first local IP address is not comprised in the IP address list of the terminals linked to the second terminal and is not the same as the second local IP address and the IP address verification request message is received a predetermined number of times or more for a preset period of time, or when a message indicating use of the first local IP address is received from the first terminal, adding the first local IP address to the IP address list of the terminals linked to the second terminal to update the list.

16. The method of claim 13, wherein the transmitting of the IP address verification response message corresponding to the positive verification response (Ack) to the first terminal comprises stopping transmitting the IP address verification response message corresponding to the positive verification response (Ack) and changing the same IP address as the first local IP address to a different IP address when the IP address verification request message comprising the first local IP address is received a preset number of times or more for a preset period of time.

17. The method of claim 16, wherein the changing of the same IP address as the first local IP address to the different IP address changes the second local IP address and transmits the changed local IP address to all terminals comprised in the IP address list of the terminals linked to the second terminal when the first local IP address is the same as the second local IP address, and requests a terminal having the same IP address as the first local IP address to change the IP address when the first local IP address is comprised in the IP address list of the terminals linked to the second terminal.

18. The method of claim 13, further comprising, when the first local IP address is the same as the second local IP address and a medial control access (MAC) address of the first terminal comprised in the IP address verification request message is a preset value, changing the second local IP address and transmitting the changed local IP address to all terminals comprised in the IP address list of the terminals linked to the second terminal.

19. A first terminal comprising:
an Internet Protocol (IP) address selector to select a first local IP address that is a local IP address of the first terminal;
a storage to store the first local IP address;
a transmitter to transmit an IP address verification request message comprising the first local IP address to a second terminal;
a receiver to receive an IP address verification response message indicating whether the first local IP address is comprised in a local IP address of the second terminal or an IP address list of the terminals linked to the second terminal; and
an IP address determiner to determine whether to use the first local IP address based on the IP address verification response message.
